(19) United States
(12) Patent Application Publication
(10) Pub. No.: US 2026/0106071 A1
(43) Pub. Date: Apr. 16, 2026

(54) CHOKE DEVICE

(71) Applicant: Yun-Kuang FAN, TAOYUAN CITY (TW)

(72) Inventor: Yun-Kuang FAN, TAOYUAN CITY (TW)

(21) Appl. No.: 19/027,311

(22) Filed: Jan. 17, 2025

(30) Foreign Application Priority Data
Oct. 11, 2024 (TW) 113211027

(51) Int. Cl. H01F 27/40; H01F 27/24; H01F 27/30; H01G 4/228; H01G 4/38

(52) U.S. Cl. CPC H01F 27/40; H01F 27/24; H01F 27/306; H01G 4/228; H01G 4/38

(57) ABSTRACT

A choke device includes an inductive structure and a capacitive structure having six capacitors. The inductive structure has a magnetic core and four coils. The first and third coils are wound on the magnetic core and their starting and ending terminals respectively extend from the top and bottom surface of the magnetic core. The second and fourth coils are wound on the magnetic core and their starting and ending terminals respectively extend from the bottom and top surface of the magnetic core. The starting terminals of the first and third coils are respectively connected to the first and fourth capacitors. The ending terminals of the second and fourth coils are respectively connected to the third and sixth capacitors. The second and fifth capacitors are respectively connected to the ending terminals of the first and third coils and respectively connected to the starting terminals of the second and fourth coils.

### CROSS-REFERENCE TO RELATED APPLICATION

This non-provisional application claims priority under 35 U.S.C. § 119(a) to Patent Application No. 113211027 filed in Taiwan, R.O.C. on Oct. 11, 2024, the entire contents of which are hereby incorporated by reference.

### BACKGROUND

### Technical Field

The present disclosure relates to an inductor, and in particular, a choke device.

### Related Art

Nowadays, electronic apparatuses are booming. The electronic apparatuses each generally needs an external power source to operate. However, electromagnetic interference (such as noise) often occurs in power transmission between the electronic apparatus and the power source. Therefore, to filter out the electromagnetic interference, an electronic filter (for example, a line filter or a choke) is generally arranged between the electronic apparatus and the power source. In the choke, components configured to filter out the electromagnetic interference are mainly a common mode inductor and a differential mode inductor, while a main component configured to provide another function (such as current limiting or reduction of a frequency response of attenuation) may be a non-inductive resistor. To improve an ability of the choke to eliminate electromagnetic interference, another passive component in addition to the inductors may be configured in the choke, and a configuration relationship between the another passive component and the inductors also affects the ability of the choke to eliminate electromagnetic interference. Therefore, how to improve the configuration relationship between the another passive component and the inductors to enhance the ability of the choke to eliminate electromagnetic interference is an extremely important issue.

### SUMMARY

In view of the above, the present disclosure provides a choke device. The choke device includes a circuit board, an inductive structure, and a capacitive structure. The inductive structure is located on the circuit board. The capacitive structure is located on the circuit board. The inductive structure includes a magnetic core, a first coil winding, and a second coil winding. The first coil winding includes a first coil and a second coil. The first coil is wound around the magnetic core to extend a first starting terminal from a top surface of the magnetic core and extend a first ending terminal from a bottom surface of the magnetic core. The second coil is wound around the magnetic core to extend a second starting terminal from the bottom surface of the magnetic core and extend a second ending terminal from the top surface of the magnetic core. The second coil winding includes a third coil and a fourth coil. The third coil is wound around the magnetic core to extend a third starting terminal from the top surface of the magnetic core and extend a third ending terminal from the bottom surface of the magnetic core. The fourth coil is wound around the magnetic core to extend a fourth starting terminal from the bottom surface of the magnetic core and extend a fourth ending terminal from the top surface of the magnetic core. The capacitive structure includes a first capacitor group and a second capacitor group. The first capacitor group includes a first capacitor, a second capacitor, and a third capacitor. One terminal of the first capacitor, one terminal of the second capacitor and one terminal of the third capacitor are connected together. The other terminal of the first capacitor is connected to the first starting terminal. The other terminal of the second capacitor, the first ending terminal and the second starting terminal are connected together. The other terminal of the third capacitor is connected to the second ending terminal. The second capacitor group includes a fourth capacitor, a fifth capacitor, and a sixth capacitor. One terminal of the fourth capacitor, one terminal of the fifth capacitor and one terminal of the sixth capacitor are connected together. The other terminal of the fourth capacitor is connected to the third starting terminal. The other terminal of the fifth capacitor, the third ending terminal and the fourth starting terminal are connected together. The other terminal of the sixth capacitor is connected to the fourth ending terminal.

To sum up, according to some embodiments, the present disclosure can improve an ability of the choke device to eliminate electromagnetic interference (that is, improve a filtering capability). In some embodiments, the present disclosure can enhance a frequency response (that is, improve a high-frequency filtering capability) of the choke device through a first capacitive structure. In some embodiments, when a current is generated in the present disclosure, a common mode inductor, a differential mode inductor or a non-inductive resistor is formed according to different combinations of the first coil, the second coil, the third coil, and the fourth coil, so that the choke device can be miniaturized, thereby meeting product requirements of a user for miniaturization of the choke device. In some embodiments, according to the present disclosure, the inductive structure is isolated from the capacitive structure by the circuit board, so as to further improve the filtering capability of the choke device.

### BRIEF DESCRIPTION OF THE DRAWINGS

FIG. 1 is a schematic perspective view of a choke device according to Embodiment 1 of the present disclosure.

FIG. 2 is a schematic rear view of the choke device according to Embodiment 1 of the present disclosure.

FIG. 3 is a schematic front view of the choke device according to Embodiment 1 of the present disclosure.

FIG. 4 is a schematic diagram of an inductive structure of the choke device according to Embodiment 1 of the present disclosure.

FIG. 5 is a schematic diagram of a circuit board and a capacitive structure of the choke device according to Embodiment 1 of the present disclosure.

FIG. 6 is a schematic equivalent circuit diagram of a choke device according to some embodiments of the present disclosure.

FIG. 7 is a schematic diagram of an inductive structure according to Embodiment 2 of the present disclosure.

FIG. 8 is a schematic perspective view of a choke device according to Embodiment 3 of the present disclosure.

FIG. 9 is a schematic diagram of a circuit board and an inductive structure of the choke device according to Embodiment 3 of the present disclosure.

FIG. 10 is a schematic diagram of a circuit board and a capacitive structure of the choke device according to Embodiment 3 of the present disclosure.

FIG. 11 shows a non-inductive resistor application circuit of a choke device according to some embodiments of the present disclosure.

FIG. 12 is a common mode noise suppression application circuit of a choke device according to some embodiments of the present disclosure.

FIG. 13 is a differential mode noise suppression application circuit of a choke device according to some embodiments of the present disclosure.

FIG. 14 to FIG. 19 are schematic diagrams of experimental data of an insertion loss of a choke device in different environments according to some embodiments of the present disclosure.

### DETAILED DESCRIPTION

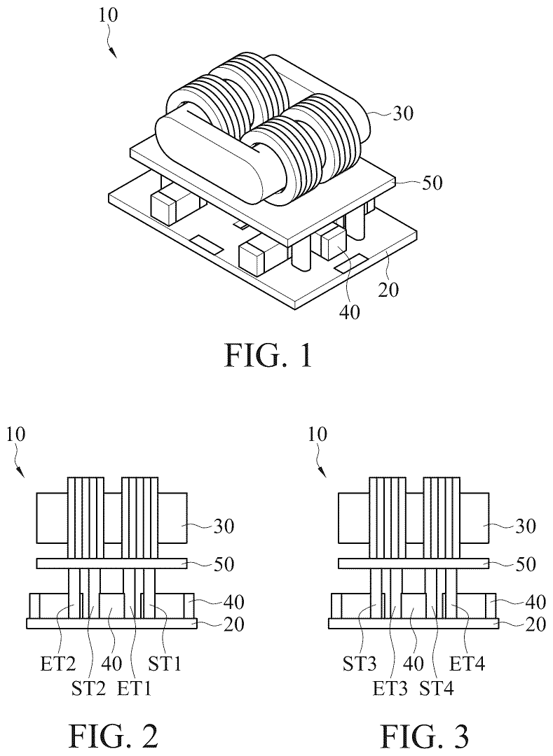

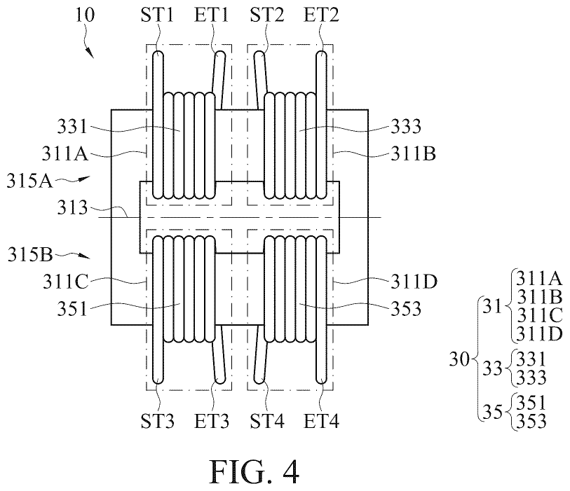

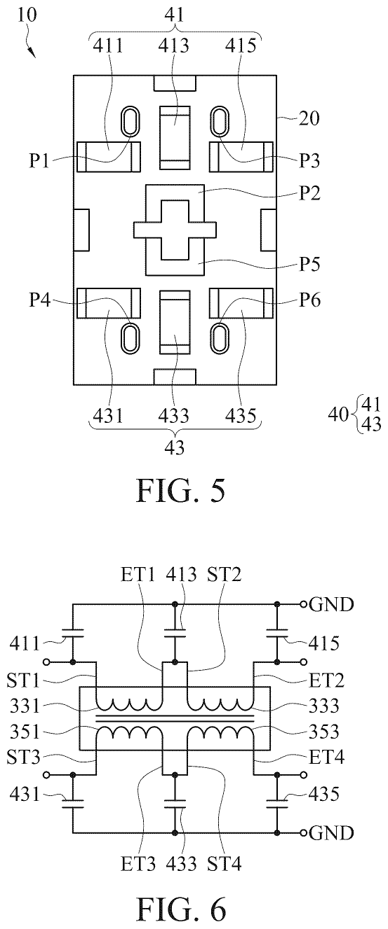

Reference is made to FIG. 1 to FIG. 5. FIG. 1 is a schematic perspective view of a choke device 10 according to Embodiment 1 of the present disclosure. FIG. 2 is a schematic rear view of the choke device 10 according to Embodiment 1 of the present disclosure. FIG. 3 is a schematic front view of the choke device 10 according to Embodiment 1 of the present disclosure. FIG. 4 is a schematic diagram of an inductive structure 30 of the choke device 10 according to Embodiment 1 of the present disclosure. FIG. 5 is a schematic diagram of a circuit board 20 and a capacitive structure 40 of the choke device 10 according to Embodiment 1 of the present disclosure. The choke device 10 includes a circuit board 20, an inductive structure 30, and a capacitive structure 40. The circuit board 20 is, for example, a printed circuit board. Both the inductive structure 30 and the capacitive structure 40 are located on the circuit board 20.

As shown in FIG. 4, the inductive structure 30 includes a magnetic core 31, a first coil winding 33, and a second coil winding 35. The magnetic core 31 may be a sintered magnetic metal oxide composed of an iron oxide mixture, such as a sintered magnetic manganese-zinc iron oxide or a nickel-zinc iron oxide. The first coil winding 33 includes a first coil 331 and a second coil 333. The second coil winding 35 includes a third coil 351 and a fourth coil 353. The first coil 331, the second coil 333, the third coil 351 and the fourth coil 353 each may be formed by winding a metal wire around the magnetic core 31. The metal wire is, for example, a single-core copper wire or a multi-core copper stranded wire. In some embodiments, the first coil 331, the second coil 333, the third coil 351 and the fourth coil 353 have the same number of coil turns.

As shown in FIG. 4, the first coil 331 is wound around the magnetic core 31 to extend a first starting terminal ST1 from a top surface of the magnetic core 31 and extend a first ending terminal ET1 from a bottom surface of the magnetic core 31. The second coil 333 is wound around the magnetic core 31 to extend a second starting terminal ST2 from the bottom surface of the magnetic core 31 and extend a second ending terminal ET2 from the top surface of the magnetic core 31. The third coil 351 is wound around the magnetic core 31 to extend a third starting terminal ST3 from the top surface of the magnetic core 31 and extend a third ending terminal ET3 from the bottom surface of the magnetic core 31. The fourth coil 353 is wound around the magnetic core 31 to extend a fourth starting terminal ST4 from the bottom surface of the magnetic core 31 and extend a fourth ending terminal ET4 from the top surface of the magnetic core 31.

Reference is made to FIG. 1 to FIG. 6. FIG. 6 is a schematic equivalent circuit diagram of a choke device 10 according to some embodiments of the present disclosure. The capacitive structure 40 includes a first capacitor group 41 and a second capacitor group 43. The first capacitor group 41 includes a first capacitor 411, a second capacitor 413, and a third capacitor 415. The second capacitor group 43 includes a fourth capacitor 431, a fifth capacitor 433, and a sixth capacitor 435. The first capacitor 411, the second capacitor 413, the third capacitor 415, the fourth capacitor 431, the fifth capacitor 433 and the sixth capacitor 435 each have two terminals (hereinafter referred to as a first terminal and a second terminal). The first terminals of the first capacitor 411, the second capacitor 413 and the third capacitor 415 are connected together by traces in the circuit board 20 and are connected to an external ground terminal GND. The second terminal of the first capacitor 411 is connected to the first starting terminal ST1 of the first coil 331. For example, the first starting terminal ST1 of the first coil 331 is connected to a contact P1 of the circuit board 20, and the contact P1 is connected to the second terminal of the first capacitor 411 by a trace in the circuit board 20. The second terminal of the second capacitor 413, the first ending terminal ET1 of the first coil 331 and the second starting terminal ST2 of the second coil 333 are connected together. For example, the first ending terminal ET1 of the first coil 331 and the second starting terminal ST2 of the second coil 333 are connected to a contact P2 of the circuit board 20, and the contact P2 is connected to the second terminal of the second capacitor 413 by a trace in the circuit board 20. The second terminal of the third capacitor 415 is connected to the second ending terminal ET2. For example, the second ending terminal ET2 of the second coil 333 is connected to a contact P3 of the circuit board 20, and the contact P3 is connected to the second terminal of the third capacitor 415 by a trace in the circuit board 20.

The first terminals of the fourth capacitor 431, the fifth capacitor 433 and the sixth capacitor 435 are connected together by traces in the circuit board 20 and are connected to an external ground terminal GND. The second terminal of the fourth capacitor 431 is connected to the third starting terminal ST3 of the third coil 351. For example, the third starting terminal ST3 of the third coil 351 is connected to a contact P4 of the circuit board 20, and the contact P4 is connected to the second terminal of the fourth capacitor 431 by a trace in the circuit board 20. The second terminal of the fifth capacitor 433, the third ending terminal ET3 of the third coil 351 and the fourth starting terminal ST4 of the fourth coil 353 are connected together. For example, the third ending terminal ET3 of the third coil 351 and the fourth starting terminal ST4 of the fourth coil 353 are connected to a contact P5 of the circuit board 20, and the contact P5 is connected to the second terminal of the fifth capacitor 433 by a trace in the circuit board 20. The second terminal of the sixth capacitor 435 is connected to the fourth ending terminal ET4 of the fourth coil 353. For example, the fourth ending terminal ET4 of the fourth coil 353 is connected to a contact P6 of the circuit board 20, and the contact P6 is connected to the second terminal of the sixth capacitor 435 by a trace in the circuit board 20. In this way, the first capacitor group 41 and the second capacitor group 43 can form resonant circuits with the first coil winding 33 and the second coil winding 35, respectively, so as to improve a frequency response (that is, improve a high-frequency filtering capability) of the choke device 10.

As shown in FIG. 4, in some embodiments, the first coil winding 33 and the second coil winding 35 are separated from each other by a gap. In this way, there is a low stray capacitance value between the first coil winding 33 and the second coil winding 35, so that the choke device 10 can have a good high-frequency filtering capability and low-frequency filtering capability at the same time.

As shown in FIG. 4, in some embodiments, the magnetic core 31 is provided with a plurality of coil regions, and the coil regions are defined at different positions in the magnetic core 31 and do not overlap each other. In some embodiments, the first coil 331, the second coil 333, the third coil 351 and the fourth coil 353 are wound in the coil regions respectively. The magnetic core 31 being provided with four coil regions (for example, a first coil region 311A to a fourth coil region 311D) is taken for description below.

For example, the first coil 331 is wound in the first coil region 311A. Through the first starting terminal ST1 and from a left terminal of an upper side of the magnetic core 31, the first coil 331 is wound rightward in a manner of being first wound from the top surface of the magnetic core 31 to the bottom surface of the magnetic core 31 and then being wound from the bottom surface of the magnetic core 31 to the top surface of the magnetic core 31, and is wound to a center of the upper side of the magnetic core 31 (that is, from left to right) to extend the first ending terminal ET1 from the bottom surface of the magnetic core 31. The second coil 333 is wound in the second coil region 311B. Through the second starting terminal ST2 and from the center of the upper side of the magnetic core 31, the second coil 333 is wound rightward in a manner of being first wound from the bottom surface of the magnetic core 31 to the top surface of the magnetic core 31 and then being wound from the top surface of the magnetic core 31 to the bottom surface of the magnetic core 31, and is wound to a right terminal of the upper side of the magnetic core 31 (that is, from left to right) to extend the second ending terminal ET2 from the top surface of the magnetic core 31. The third coil 351 is wound in the third coil region 311C. Through the third starting terminal ST3 and from a left terminal of a lower side of the magnetic core 31, the third coil 351 is wound rightward in a manner of being first wound from the top surface of the magnetic core 31 to the bottom surface of the magnetic core 31 and then being wound from the bottom surface of the magnetic core 31 to the top surface of the magnetic core 31, and is wound to a center of the lower side of the magnetic core 31 (that is, from left to right) to extend the third ending terminal ET3 from the bottom surface of the magnetic core 31. The fourth coil 353 is wound in the fourth coil region 311D. Through the fourth starting terminal ST4 and from the center of the lower side of the magnetic core 31, the fourth coil 353 is wound rightward in a manner of being first wound from the bottom surface of the magnetic core 31 to the top surface of the magnetic core 31 and then being wound from the top surface of the magnetic core 31 to the bottom surface of the magnetic core 31, and is wound to a right terminal of the lower side of the magnetic core 31 (that is, from left to right) to extend the fourth ending terminal ET4 from the top surface of the magnetic core 31.

In this way, the first ending terminal ET1 of the first coil 331 is adjacent to the second starting terminal ST2 of the second coil 333, and the first starting terminal ST1 of the first coil 331 is away from the second ending terminal ET2 of the second coil 333. The third ending terminal ET3 of the third coil 351 is adjacent to the fourth starting terminal ST4 of the fourth coil 353, and the third starting terminal ST3 of the third coil 351 is away from the fourth ending terminal ET4 of the fourth coil 353. The first starting terminal ST1 of the first coil 331 is adjacent to the third starting terminal ST3 of the third coil 351, and the second ending terminal ET2 of the second coil 333 is adjacent to the fourth ending terminal ET4 of the fourth coil 353.

As shown in FIG. 4, in some embodiments, the first coil region 311A and the fourth coil region 311D are located between the second coil region 311B and the third coil region 311C. The second coil region 311B and the third coil region 311C are located between the first coil region 311A and the fourth coil region 311D. The first coil region 311A and the fourth coil region 311D are not adjacent to each other, and the second coil region 311B and the third coil region 311C are not adjacent to each other. In this way, the first coil 331 and the fourth coil 353 are both located between the second coil 333 and the third coil 351, while the second coil 333 and the third coil 351 are both located between the first coil 331 and the fourth coil 353, and the first coil 331 and the fourth coil 353 are not adjacent to each other, while the second coil 333 and the third coil 351 are not adjacent to each other.

As shown in FIG. 4, in some embodiments, adjacent coil regions (such as the first coil region 311A and the second coil region 311B) are separated from each other by a gap, so that coils wound therein (such as the first coil 331 and the second coil 333) are also separated from each other by the gap to have lower stray capacitance values, such that the choke device 10 can have a good high-frequency filtering capability and low-frequency filtering capability at the same time.

As shown in FIG. 4, in some embodiments, the first coil winding 33 and the second coil winding 35 are symmetrical to each other. For example, the magnetic core 31 is divided into an upper region 315A and a lower region 315B via its own central axis 313. The first coil winding 33 is located in the upper region 315A of the magnetic core 31, and the second coil winding 35 is located in the lower region 315B of the magnetic core 31. The first coil 331 of the first coil winding 33 is symmetrical to the third coil 351 of the second coil winding 35 according to the central axis 313 of the magnetic core 31. The second coil 333 of the first coil winding 33 is symmetrical to the fourth coil 353 of the second coil winding 35 according to the central axis 313 of the magnetic core 31. Specifically, the first coil 331 and the third coil 351 are biased on same sides (for example, left sides) of the upper region 315A and the lower region 315B of the magnetic core 31 respectively, and the first starting terminal ST1 of the first coil 331 and the third starting terminal ST3 of the third coil 351 are located at the same terminals (for example, left terminals) of the first coil 331 and the third coil 351 respectively and both extend from the top surface of the magnetic core 31. The first ending terminal ET1 of the first coil 331 and the third ending terminal ET3 of the third coil 351 are located at the same terminals (for example, right terminals) of the first coil 331 and the third coil 351 respectively, and both extend from the bottom surface of the magnetic core 31. Therefore, the first coil 331 is symmetrical to the third coil 351. The second coil 333 and the fourth coil 353 are biased on same sides (for example, right sides) of the upper region 315A and the lower region 315B of the magnetic core 31 respectively, and the second starting terminal ST2 of the second coil 333 and the fourth starting terminal ST4 of the fourth coil 353 are located at the same terminals (for example, left terminals) of the second coil 333 and the fourth coil 353 respectively and both extend from the bottom surface of the magnetic core 31. The second ending terminal ET2 of the second coil 333 and the fourth ending terminal ET4 of the fourth coil 353 are located at the same terminals (for example, right terminals) of the second coil 333 and the fourth coil 353 respectively, and both extend from the top surface of the magnetic core 31. Therefore, the second coil 333 is symmetrical to the fourth coil 353.

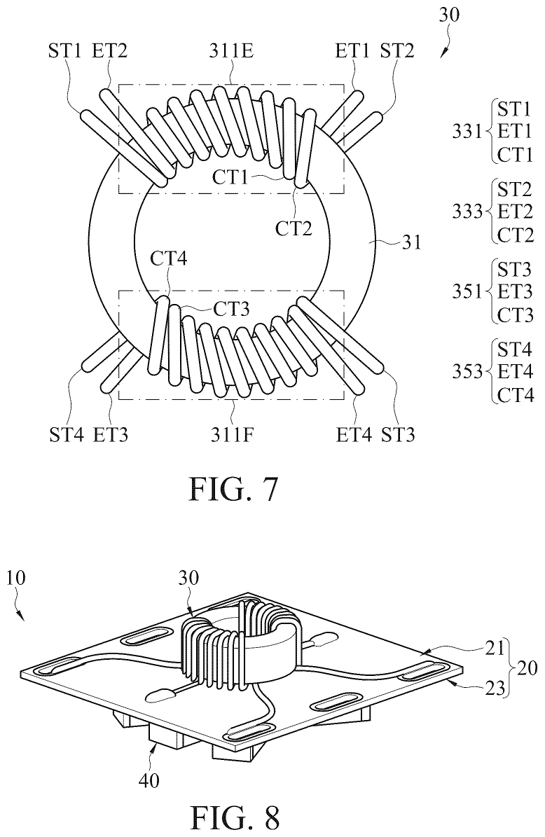

FIG. 7 is a schematic diagram of an inductive structure 30 according to Embodiment 2 of the present disclosure. In some embodiments, the first coil 331 and the second coil 333 are wound in one of the coil regions, and the third coil 351 and the fourth coil 353 are wound in another of the coil regions. The magnetic core 31 being provided with two coil regions (for example, a fifth coil region 311E and a sixth coil region 311F) is taken for description below.

For example, the first coil 331 and the second coil 333 are wound in the fifth coil region 311E. Through the first starting terminal ST1 and from the left terminal of the upper side of the magnetic core 31, the first coil 331 is wound rightward in a manner of being first wound from the top surface of the magnetic core 31 to the bottom surface of the magnetic core 31 and then being wound from the bottom surface of the magnetic core 31 to the top surface of the magnetic core 31, and is wound to the right terminal of the upper side of the magnetic core 31 (that is, from left to right) to extend the first ending terminal ET1 from the bottom surface of the magnetic core 31. Through the second starting terminal ST2 and from the right terminal of the upper side of the magnetic core 31, the second coil 333 is wound leftward in a manner of being first wound from the bottom surface of the magnetic core 31 to the top surface of the magnetic core 31 and then being wound from the top surface of the magnetic core 31 to the bottom surface of the magnetic core 31, and is wound to the left terminal of the upper side of the magnetic core 31 (that is, from right to left) to extend the second ending terminal ET2 from the top surface of the magnetic core 31. The third coil 351 and the fourth coil 353 are wound in the sixth coil region 311F. Through the third starting terminal ST3 and from the right terminal of a lower side of the magnetic core 31, the third coil 351 is wound leftward in a manner of being first wound from the top surface of the magnetic core 31 to the bottom surface of the magnetic core 31 and then being wound from the bottom surface of the magnetic core 31 to the top surface of the magnetic core 31, and is wound to the left terminal of the lower side of the magnetic core 31 (that is, from right to left) to extend the third ending terminal ET3 from the bottom surface of the magnetic core 31. Through the fourth starting terminal ST4 and from the left terminal of the lower side of the magnetic core 31, the fourth coil 353 is wound rightward in a manner of being first wound from the bottom surface of the magnetic core 31 to the top surface of the magnetic core 31 and then being wound from the top surface of the magnetic core 31 to the bottom surface of the magnetic core 31, and is wound to the right terminal of the lower side of the magnetic core 31 (that is, from left to right) to extend the fourth ending terminal ET4 from the top surface of the magnetic core 31.

In this way, the first ending terminal ET1 of the first coil 331 is adjacent to the second starting terminal ST2 of the second coil 333, and the first starting terminal ST1 of the first coil 331 is adjacent to the second ending terminal ET2 of the second coil 333. The third ending terminal ET3 of the third coil 351 is adjacent to the fourth starting terminal ST4 of the fourth coil 353, and the third starting terminal ST3 of the third coil 351 is adjacent to the fourth ending terminal ET4 of the fourth coil 353. The first starting terminal ST1 of the first coil 331 and the second ending terminal ET2 of the second coil 333 are adjacent to the third ending terminal ET3 of the third coil 351 and the fourth starting terminal ST4 of the fourth coil 353, and the first ending terminal ET1 of the first coil 331 and the second starting terminal ST2 of the second coil 333 are adjacent to the third starting terminal ST3 of the third coil 351 and the fourth ending terminal ET4 of the fourth coil 353.

As shown in FIG. 7, in some embodiments, the first coil 331 and the second coil 333 that are wound in the same coil region have opposite winding directions, and the third coil 351 and the fourth coil 353 that are wound in the same coil region have opposite winding directions. For example, the winding direction of the first coil 331 is from left to right, and the winding direction of the second coil 333 is from right to left. The winding direction of the third coil 351 is from right to left, and the winding direction of the fourth coil 353 is from left to right.

As shown in FIG. 7, in some embodiments, coil turns of the first coil 331 and the second coil 333 that are wound in the same coil region are interlaced with each other, and coil turns of the third coil 351 and the fourth coil 353 that are wound in the same coil region are interlaced with each other. For example, from a left terminal to a right terminal of the fifth coil region 311E (that is, from left to right), an arrangement order of coil turns of the first coil 331 (hereinafter referred to as first coil turns CT1) and coil turns of the second coil 333 (hereinafter referred to as second coil turns CT2) is “first coil turn CT1, second coil turn CT2, first coil turn CT1, second coil turn CT2, first coil turn CT1, second coil turn CT2, first coil turn CT1, second coil turn CT2, . . .”. From a right terminal to a left terminal of the sixth coil region 311F (that is, from right to left), an arrangement order of coil turns of the third coil 351 (hereinafter referred to as third coil turns CT3) and coil turns of the fourth coil 353 (hereinafter referred to as fourth coil turns CT4) is “third coil turn CT3, fourth coil turn CT4, third coil turn CT3, fourth coil turn CT4, third coil turn CT3, fourth coil turn CT4, third coil turn CT3, fourth coil turn CT4, . . .”.

In some embodiments, the magnetic core 31 may be implemented by a closed magnetic core or a non-closed magnetic core. In some embodiments, when the magnetic core 31 is implemented by a closed magnetic core, the closed magnetic core may be a circular magnetic core (as shown in FIG. 7), an elliptical magnetic core, a rectangular magnetic core (as shown in FIG. 4), an EE type magnetic core, or a closed magnetic core in another shape.

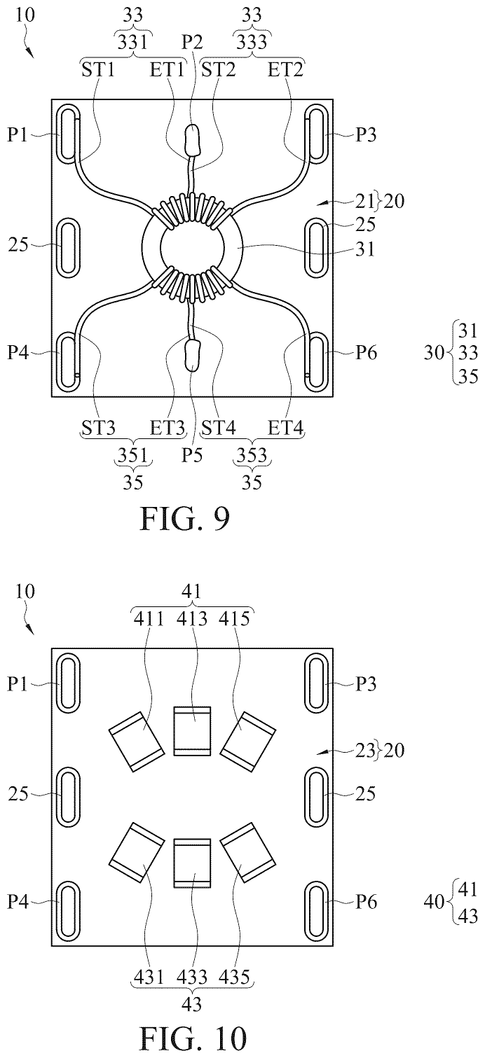

Reference is made to FIG. 6 and FIG. 8 to FIG. 10. FIG. 8 is a schematic perspective view of a choke device 10 according to Embodiment 3 of the present disclosure. FIG. 9 is a schematic diagram of a circuit board 20 and an inductive structure 30 of the choke device 10 according to Embodiment 3 of the present disclosure. FIG. 10 is a schematic diagram of a circuit board 20 and a capacitive structure 40 of the choke device 10 according to Embodiment 3 of the present disclosure. In some embodiments, the first ending terminal ET1 of the first coil 331 and the second starting terminal ST2 of the second coil 333 can be integrated (for example, stranded) into a single terminal and connected to the second terminal of the second capacitor 413 by the contact P2 and a trace of the circuit board 20. The third ending terminal ET3 of the third coil 351 and the fourth starting terminal ST4 of the fourth coil 353 can be integrated (for example, stranded) into a single terminal and connected to the second terminal of the fifth capacitor 433 by the contact P5 and a trace of the circuit board 20.

As shown in FIG. 1 to FIG. 3, in some embodiments, the inductive structure 30 and the capacitive structure 40 are located on a same surface of the circuit board 20, and the capacitive structure 40 is located between the inductive structure 30 and the circuit board 20. However, the present disclosure is not limited to this. As shown in FIG. 8 to FIG. 10, in some embodiments, the circuit board 20 includes a top surface 21 and a bottom surface 23 that are opposite. The inductive structure 30 is located at the top surface 21 of the circuit board 20, and the capacitive structure 40 is located at the bottom surface 23 of the circuit board 20. That is, the circuit board 20 is located between the inductive structure 30 and the capacitive structure 40. In this way, the circuit board 20 isolates the inductive structure 30 from the capacitive structure 40, so as to avoid mutual interference between the inductive structure 30 and the capacitive structure 40, thereby enhancing an electromagnetic interference elimination capability (that is, enhancing a filtering capability) of the choke device 10.

As shown in FIG. 1 to FIG. 3, in some embodiments, the choke device 10 further includes an isolation plate 50. The isolation plate 50 is, for example, an insulating plate. The isolation plate 50 is located at a bottom of the inductive structure 30 to isolate the inductive structure 30 from the capacitive structure 40, so as to avoid mutual interference between the inductive structure 30 and the capacitive structure 40, and improve an electromagnetic interference elimination capability of the choke device 10.

In some embodiments, the circuit board 20, the inductive structure 30 and the capacitive structure 40 can be encapsulated in a housing to form an electronic module, and the first starting terminal ST1, the second ending terminal ET2, the third starting terminal ST3 and the fourth ending terminal ET4 are used as external connection terminals of the electronic module. In some embodiments, external connection terminals of the electronic module further include a ground connection terminal 25 (as shown in FIG. 9 and FIG. 10) to connect the first terminals of the first capacitor 411, the second capacitor 413, the third capacitor 415, the fourth capacitor 431, the fifth capacitor 433 and the sixth capacitor 435 with an external ground terminal GND. In some embodiments, the first starting terminal ST1 of the first coil 331 and the third starting terminal ST3 of the third coil 351 form a first input/output terminal of the choke device 10 (that is, a first input/output terminal group among the external connection terminals of the electronic module) to be connected to a corresponding circuit assembly. The second ending terminal ET2 of the second coil 333 and the fourth ending terminal ET4 of the fourth coil 353 form a second input/output terminal of the choke device 10 (that is, a second input/output terminal group among the external connection terminals of the electronic module) to be connected to a corresponding circuit assembly. In this way, the choke device 10 can eliminate electromagnetic interference.

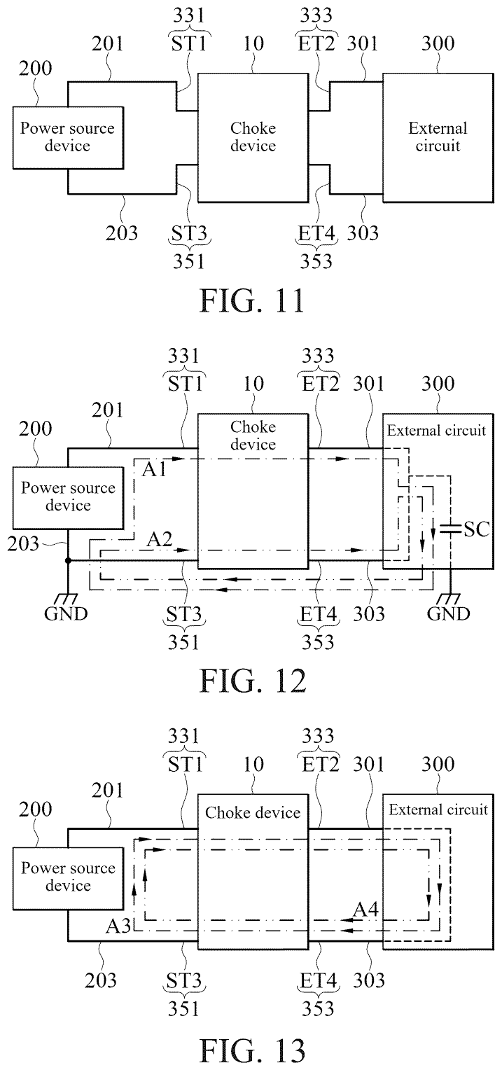

Reference is made to FIG. 6 and FIG. 11. FIG. 11 shows a non-inductive resistor application circuit of a choke device 10 according to some embodiments of the present disclosure. Then, the first input/output terminal of the choke device 10 is connected to a power source device 200, and the second input/output terminal of the choke device 10 is connected to an external circuit to be filtered (hereinafter referred to as an external circuit 300) to illustrate a non-inductive resistor application circuit, a common mode noise suppression application circuit, and a differential mode noise suppression application circuit. The first starting terminal ST1 of the first coil 331 is connected to a first power supply terminal 201 of the power source device 200, and the third starting terminal ST3 of the third coil 351 is connected to a second power supply terminal 203 of the power source device 200. The second ending terminal ET2 of the second coil 333 is connected to a first input terminal 301 of the external circuit 300. The fourth ending terminal ET4 of the fourth coil 353 is connected to a second input terminal 303 of the external circuit 300.

As shown in FIG. 6 and FIG. 11, in some embodiments, when the choke device 10 receives a current through the first input/output terminal or the second input/output terminal, the first coil 331 and the second coil 333 form a non-inductive resistor, and the third coil 351 and the fourth coil 353 form a non-inductive resistor. For example, the current generated by the power source device 200 (hereinafter referred to as a supply current) flows through the first coil 331 and the second coil 333 from the first power supply terminal 201 to the first input terminal 301 of the external circuit 300, and then flows through the fourth coil 353 and the third coil 351 from the second input terminal 303 of the external circuit 300 to the second power supply terminal 203 of the power source device 200. Due to opposite magnetic fields generated by the first coil 331 and the second coil 333, the magnetic fields cancel each other out and do not produce any inductive reactance. In other words, in this case, the first coil 331 and the second coil 333 are resistors without inductive reactance (such as having only resistance values of the coils) or inductors generated by only small leakage inductance, that is, the first coil 331 and the second coil 333 form a substantially non-inductive resistor. Similarly, the third coil 351 and the fourth coil 353 also form a substantially non-inductive resistor due to the generation of magnetic fields in opposite directions. In this way, the non-inductive resistor can be applied to functions required for the external circuit 300 (such as current limiting, and reduction of a fading frequency response).

Reference is made to FIG. 6 and FIG. 12. FIG. 12 is a common mode noise suppression application circuit of a choke device 10 according to some embodiments of the present disclosure. In some embodiments, when the choke device 10 receives a common mode current through the first input/output terminal or the second input/output terminal, the first coil 331 and the third coil 351 form a common mode inductor, and the second coil 333 and the fourth coil 353 form a common mode inductor. For example, when the external circuit 300 is connected to a ground terminal GND (for example, a housing of the external circuit 300 is grounded), due to stray capacitance SC between the external circuit 300 and the ground terminal GND, stray signals (such as common mode noise, also referred to as a common mode current) is generated between the first power supply terminal 201 and the ground terminal GND of the power source device 200 and between the second power supply terminal 203 thereof and the ground terminal GND. The common mode current includes a first stray current generated by the first power supply terminal 201 of the power source device 200 through stray capacitance SC and a second stray current generated by the second power supply terminal 203 of the power source device 200 through stray capacitance SC. A current direction A1 of the first stray current (indicated by a one-dot chain line in FIG. 12) is the same as a current direction A2 of the second stray current (indicated by a two-dot chain line in FIG. 12). The first stray current flows through the first coil 331 and the second coil 333 from the first power supply terminal 201 of the power source device 200, then flows to the first input terminal 301 of the external circuit 300, and returns to the power source device 200 through the ground terminal GND. The second stray current flows through the third coil 351 and the fourth coil 353 from the second power supply terminal 203 of the power source device 200, then flows to the second input terminal 303 of the external circuit 300, and returns to the power source device 200 through the ground terminal GND. In this case, the first coil 331 and the third coil 351 generate magnetic fields in the same direction, thereby enhancing inductance of the first coil 331 and the third coil 351, that is, enhancing inductive reactance for suppressing the common mode current (in other words, the first coil 331 and the third coil 351 form a common mode inductor in this case). Similarly, the second coil 333 and the fourth coil 353 also generate magnetic fields in the same direction, thereby enhancing inductive reactance for suppressing the common mode current. In this way, an effect of filtering out the common mode noise can be achieved.

Reference is made to FIG. 6 and FIG. 13. FIG. 13 is a differential mode noise suppression application circuit of a choke device 10 according to some embodiments of the present disclosure. In some embodiments, when the choke device 10 receives a differential mode current through the first input/output terminal or the second input/output terminal, the first coil 331 and the fourth coil 353 form a differential mode inductor, and the second coil 333 and the third coil 351 form a differential mode inductor. For example, noise (that is, differential mode noise, also referred to as a differential mode current) may be generated between the first power supply terminal 201 and the second power supply terminal 203 of the power source device 200. A current direction A3 of the differential mode current (indicated by a one-dot chain line in FIG. 13) is the same as a current direction A4 of the supply current of the power source device 200 (indicated by a two-dot chain line in FIG. 13). The differential mode current flows through the first coil 331 and the second coil 333 from the first power supply terminal 201 to the first input terminal 301 of the external circuit 300, and then flows through the fourth coil 353 and the third coil 351 from the second input terminal 303 of the external circuit 300 to the second power supply terminal 203 of the power source device 200. In this case, the first coil 331 and the fourth coil 353 generate magnetic fields in the same direction, thereby enhancing inductance of the first coil 331 and the fourth coil 353, that is, enhancing inductive reactance for suppressing the differential mode current (in other words, the first coil 331 and the fourth coil 353 form a differential mode inductor in this case). Similarly, the second coil 333 and the third coil 351 also generate magnetic fields in the same direction, thereby enhancing inductive reactance for suppressing the differential mode current. In this way, an effect of filtering out the differential mode noise can be achieved.

From the above, it can be seen that the inductive structure 30 of the choke device 10 has a simple coil winding structure, and therefore can be implemented through automatic winding by a winding machine to improve product production efficiency and can further reduce mutual interference between coil windings.

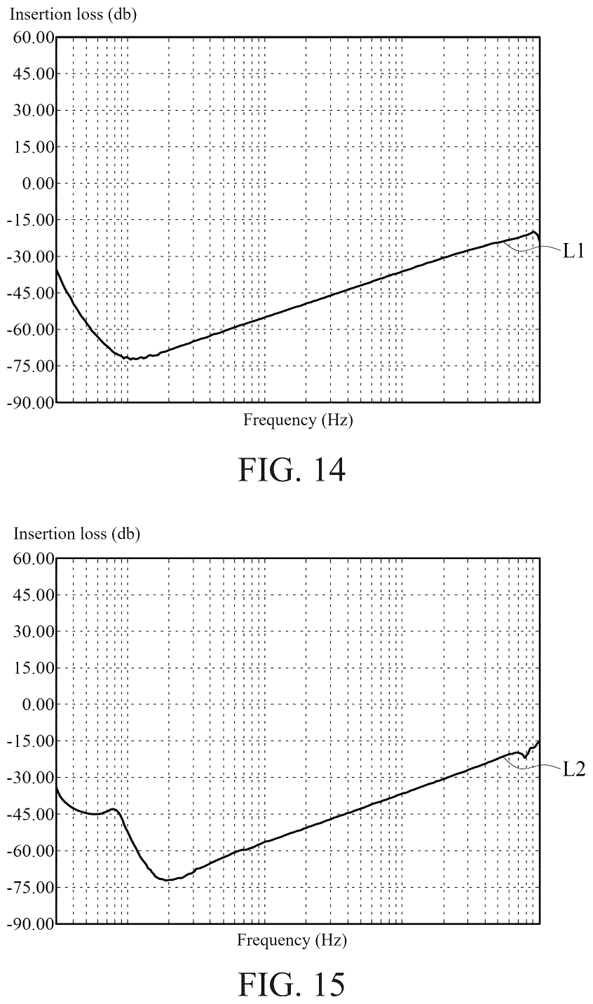

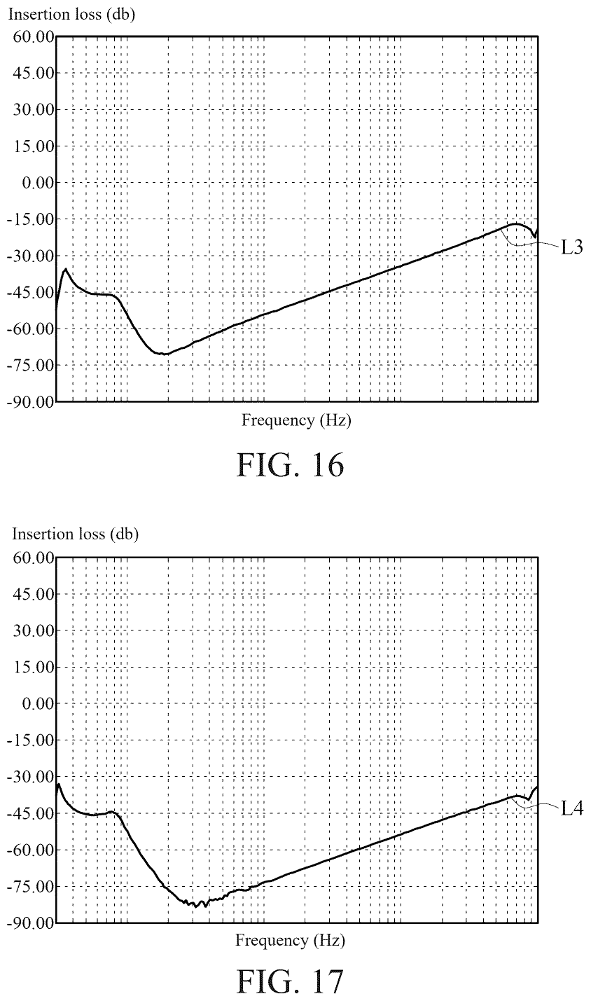

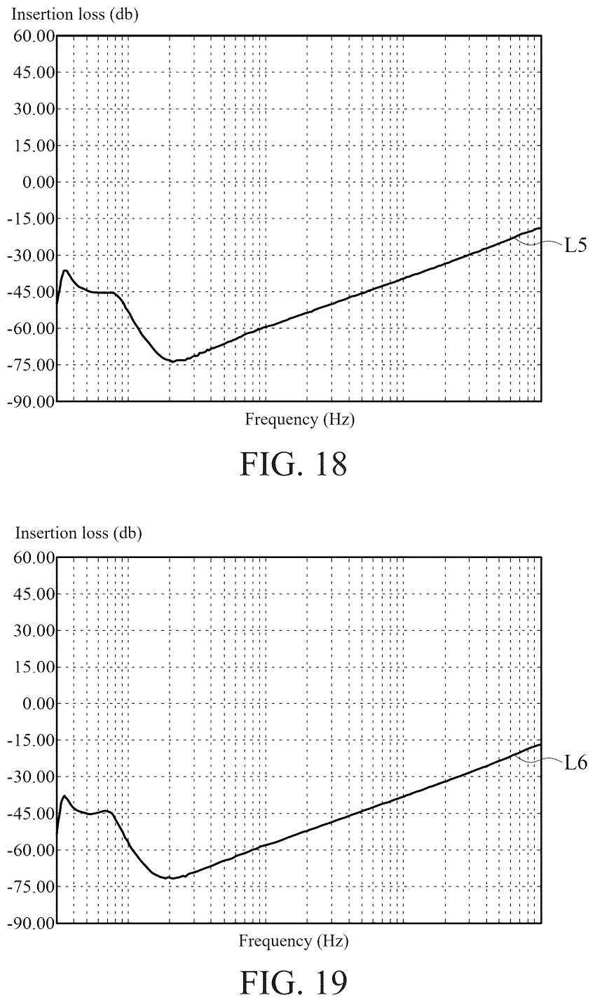

FIG. 14 to FIG. 19 are schematic diagrams of experimental data of an insertion loss of a choke device 10 in different environments according to some embodiments of the present disclosure. A curve L1 shows an insertion loss of the choke device 10 adapted to a high current (for example, 10 amperes). A curve L2 shows an insertion loss of the choke device 10 adapted to a medium current (for example, 8 amperes). Curves L3 to L6 are insertion losses of the choke device 10 adapted to a low current (for example, 3 amperes) in different environments. From FIG. 14 to FIG. 19, it can be seen that the choke device 10 adapted to different current magnitudes has good insertion loss performance in different environments.

To sum up, according to some embodiments, the present disclosure can improve an ability of the choke device to eliminate electromagnetic interference (that is, improve a filtering capability). In some embodiments, the present disclosure can enhance a frequency response (that is, improve a high-frequency filtering capability) of the choke device through a first capacitive structure. In some embodiments, when a current is generated in the present disclosure, a common mode inductor, a differential mode inductor or a non-inductive resistor is formed according to different combinations of the first coil, the second coil, the third coil, and the fourth coil, so that the choke device can be miniaturized, thereby meeting product requirements of a user for miniaturization of the choke device. In some embodiments, according to the present disclosure, the inductive structure is isolated from the capacitive structure by the circuit board, so as to further improve the filtering capability of the choke device.

What is claimed is:

1. A choke device, comprising:
a circuit board;
an inductive structure located on the circuit board, wherein the inductive structure comprises:
a magnetic core;
a first coil winding comprising a first coil and a second coil, wherein the first coil is wound around the magnetic core to extend a first starting terminal from a top surface of the magnetic core and extend a first ending terminal from a bottom surface of the magnetic core, and the second coil is wound around the magnetic core to extend a second starting terminal from the bottom surface of the magnetic core and extend a second ending terminal from the top surface of the magnetic core; and
a second coil winding comprising a third coil and a fourth coil, wherein the third coil is wound around the magnetic core to extend a third starting terminal from the top surface of the magnetic core and extend a third ending terminal from the bottom surface of the magnetic core, and the fourth coil is wound around the magnetic core to extend a fourth starting terminal from the bottom surface of the magnetic core and extend a fourth ending terminal from the top surface of the magnetic core; and
a capacitive structure located on the circuit board, wherein the capacitive structure comprises:
a first capacitor group comprising a first capacitor, a second capacitor, and a third capacitor, wherein one terminal of the first capacitor, one terminal of the second capacitor and one terminal of the third capacitor are connected together, and the other terminal of the first capacitor is connected to the first starting terminal; the other terminal of the second capacitor, the first ending terminal and the second starting terminal are connected together, and the other terminal of the third capacitor is connected to the second ending terminal; and
a second capacitor group comprising a fourth capacitor, a fifth capacitor, and a sixth capacitor, wherein one terminal of the fourth capacitor, one terminal of the fifth capacitor and one terminal of the sixth capacitor are connected together, and the other terminal of the fourth capacitor is connected to the third starting terminal; the other terminal of the fifth capacitor, the third ending terminal and the fourth starting terminal are connected together, and the other terminal of the sixth capacitor is connected to the fourth ending terminal.

2. The choke device according to claim 1, wherein the magnetic core is provided with a plurality of coil regions, and the first coil, the second coil, the third coil and the fourth coil are wound in the coil regions respectively.

3. The choke device according to claim 1, wherein the magnetic core is provided with a plurality of coil regions, the first coil and the second coil are wound in one of the coil regions, and the third coil and the fourth coil are wound in another of the coil regions.

4. The choke device according to claim 3, wherein coil turns of the first coil and the second coil are interlaced with each other, and coil turns of the third coil and the fourth coil are interlaced with each other.

5. The choke device according to claim 1, wherein the first starting terminal and the third starting terminal form a first input/output terminal of the choke device, and the second ending terminal and the fourth ending terminal form a second input/output terminal of the choke device.

6. The choke device according to claim 5, wherein when receiving a current through the first input/output terminal or the second input/output terminal, the first coil and the second coil form a non-inductive resistor, and the third coil and the fourth coil form a non-inductive resistor.

7. The choke device according to claim 6, wherein when the current is a common mode current, the first coil and the third coil form a common mode inductor, and the second coil and the fourth coil form a common mode inductor.

8. The choke device according to claim 6, wherein when the current is a differential mode current, the first coil and the fourth coil form a differential mode inductor, and the second coil and the third coil form a differential mode inductor.

9. The choke device according to claim 1, wherein the one terminal of the first capacitor, the one terminal of the second capacitor, the one terminal of the third capacitor, the one terminal of the fourth capacitor, the one terminal of the fifth capacitor and the one terminal of the sixth capacitor are connected to a ground terminal.

10. The choke device according to claim 1, wherein the first coil, the second coil, the third coil and the fourth coil have a same number of coil turns.

11. The choke device according to claim 1, wherein the inductive structure and the capacitive structure are located on a same surface of the circuit board, and the capacitive structure is located between the inductive structure and the circuit board.

12. The choke device according to claim 1, wherein the circuit board comprises a top surface and a bottom surface that are opposite, the inductive structure is located at the top surface, and the capacitive structure is located at the bottom surface.
